(19) United States
(12) Patent Application Publication
(10) Pub. No.: US 2007/0229414 A1
(43) Pub. Date: Oct. 4, 2007

(54) Dual OLED panel module

(76) Inventor: Chiung-Ching Ku, Zhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,594

(22) Filed: Apr. 3, 2007

(30) Foreign Application Priority Data
Apr. 4, 2006 (TW) 095112053

(51) Int. Cl. G09G 3/30

(52) U.S. Cl. 345/76

(57) ABSTRACT

A dual OLED panel module uses a common package for linking two display panels. The common package has wires for a controller chip to deliver driving signals to drive the two panels simultaneously or either one. The dual OLED panel module needs fewer components, has smaller mechanical dimension, and requires lower cost.

### FIELD OF THE INVENTION

The present invention is related generally to an organic light-emitting diode (OLED) display and, more particularly, to a dual OLED panel module.

### BACKGROUND OF THE INVENTION

For providing some additional functions, a portable device nowadays is usually equipped with two displays. For example, a mobile fold phone has a main display inside to display the images of texts and pictures when the user opens up the fold phone and operates for phone calling or data searching, and a sub-display outside to display time information and caller ID without opening up the fold phone. Another example is using the camera function of a portable device. When shooting on an object, the user can monitor the shot range from the main display inside, and when the user shoots on himself, he can monitor the shot range from the sub-display outside. With such additional functions becoming the basic functions of consumer electronic products, dual panel module becomes the basic equipment of those products.

However, to drive two panels, a conventional dual panel module needs two driver chips and with two packages, and therefore, it needs higher cost and larger mechanical dimension. FIG. 1 shows a conventional dual OLED panel module, in which a main panel module 105 has a main panel 10 to display images, a main controller chip 14 to drive the main panel 10, and a package 12 to package the main controller chip 14 to the main panel 10, and a sub-panel module 205 has a sub-panel 20 to display images, a sub-controller chip 24 to drive the sub-panel 20, and a package 22 to package the sub-controller chip 24 to the sub-panel 10. To combine the main panel module 105 and the sub-panel module 205 together, a printed circuit board (PCB) 30 is provided, with which the main panel module 105 and the sub-panel module 205 are attached on the opposite sides of the PCB. In the right side of FIG. 2, it is shown the front side of the dual OLED panel module of FIG. 1, namely the main panel module 105, in which a bonding area 120 of the package 12 is bonded on the main panel 10, a bonding area 122 of the package 12 is bonded on the PCB 30, and the main controller chip 14 is bonded on the center of the package 12. The package 12 has wires 16 thereon, to provide the signal paths between the main controller chip 14 and the main panel 10 and between the PCB 30 and the main controller chip 14. In the left side of FIG. 2, it is shown the back side of the dual OLED panel module of FIG. 1, namely the sub-panel module 205, in which a bonding area 220 of the package 22 is bonded on the sub-panel 20, a bonding area 222 of the package 22 is bonded on the PCB 30, and the sub-controller chip 24 is bonded on the center of the package 22. The package 22 has wires 26 thereon, to provide the signal paths between the sub-controller chip 24 and the sub-panel 20 and between the PCB 30 and the sub-controller chip 24. The control signals from outside of the dual OLED panel module are sent to the PCB 30, and then delivered to the main panel module 105 and the sub-panel module 205 through the bonding areas 122 and 222, respectively. The PCB 30 also has wires (not shown) to provide the signal paths between the main panel module 105 and the sub-panel module 205. As shown in FIG. 1, the thickness of the dual OLED panel module includes the thickness of the main panel 10, the thickness of the sub-panel 20, and the thickness of the PCB 30, and the height of the dual OLED panel module is the height of the main panel 10 and the height of the package 12.

To meet the demands of lighter, thinner, shorter and smaller for the consumer electronic products, and to reduce the cost, a dual OLED panel module with lower cost and smaller mechanical dimension is desired.

### SUMMARY OF THE INVENTION

An object of the present invention is to provide a dual OLED panel module with low cost and small mechanical dimension.

According to the present invention, a dual OLED panel module comprises a common package having two bonding areas for bonding to two panels respectively, and wires for providing signal paths, and a controller chip for producing driving signals in response to external control signals to drive either one or both of the two panels through the wires on the common package.

The dual OLED panel module according to the present invention does not require a PCB to combine the two panels together, and needs one less package and controller chip than a conventional dual OLED panel module. Therefore, the cost is lower, the thickness is reduced, and the mechanical dimension is smaller.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a side view of a conventional dual OLED panel module;

FIG. 2 shows the front side and back side of the dual OLED panel module shown in FIG. 1;

FIG. 3 is an expansion diagram of a dual OLED panel module according to the present invention;

FIG. 4 is a side view of the dual OLED panel module shown in FIG. 3 when the common package thereof is folded;

FIG. 5 shows the front side and back side of the dual OLED panel module shown in FIG. 4;

FIG. 6 shows an embodiment for the common package of FIG. 3;

FIG. 7 shows an embodiment for the controller chip of FIG. 3;

FIG. 8 shows another embodiment for the controller chip of FIG. 3;

FIG. 9 shows the signals of the controller chip of FIG. 7 when the main panel and the sub-panel both are active;

FIG. 10 shows the signals of the controller chip of FIG. 7 when the main panel is active and the sub-panel is turned off;

FIG. 11 shows the signals of the controller chip of FIG. 7 when the main panel is turned off and the sub-panel is active; and

FIG. 12 shows the signals of the controller chip of FIG. 7 when the main panel and the sub-panel both are turned off.

### DETAILED DESCRIPTION OF THE INVENTION

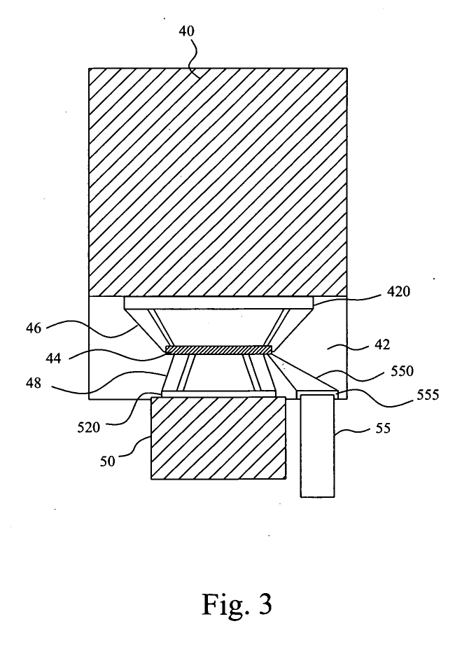

FIG. 3 shows an embodiment according to the present invention, in which a dual OLED panel module comprises a main panel 40 and a sub-panel 50 using a common package 42. For example, the common package 42 is a polymer tape with metal wires thereon, and by tape automated bonding (TAB), bonded to the main panel 40 with a bonding area 420, to the sub-panel 50 with a bonding area 520, to a connector 55 with a bonding area 555, and with a controller chip 44 bonded on the center thereof. The connector 55 usually has a substrate, such as flexible printed circuit board (FPC), hot bar, and PCB, and a circuit on the substrate electrically connected to the connector wires 550 of the common package 42 for the signals between the controller chip 44 and the apparatus outside the dual OLED panel module to deliver therethrough. The controller chip 44 receives external control signals, and produces driving signals accordingly to transmit to the main panel 40 and the sub-panel 50 through the wires 46 and 48 to drive the main panel 40 and the sub-panel 50 simultaneously or either one.

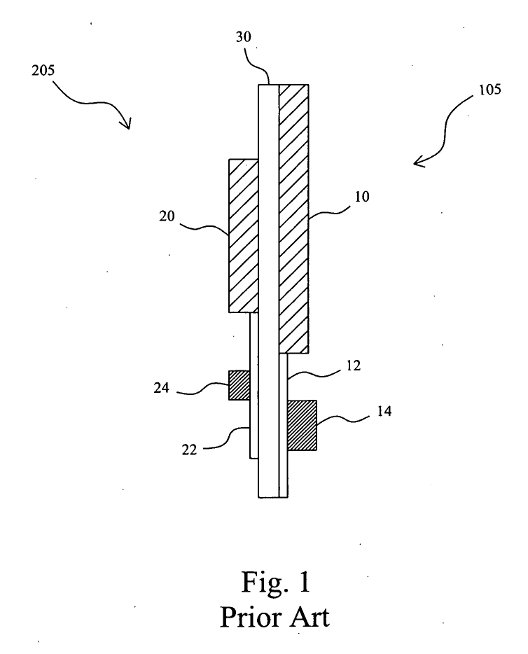

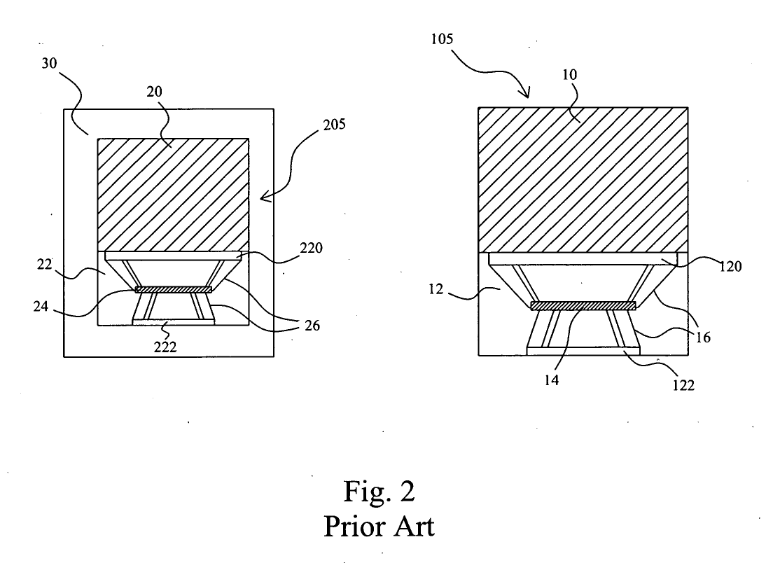

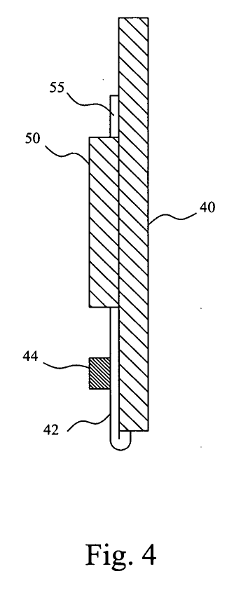

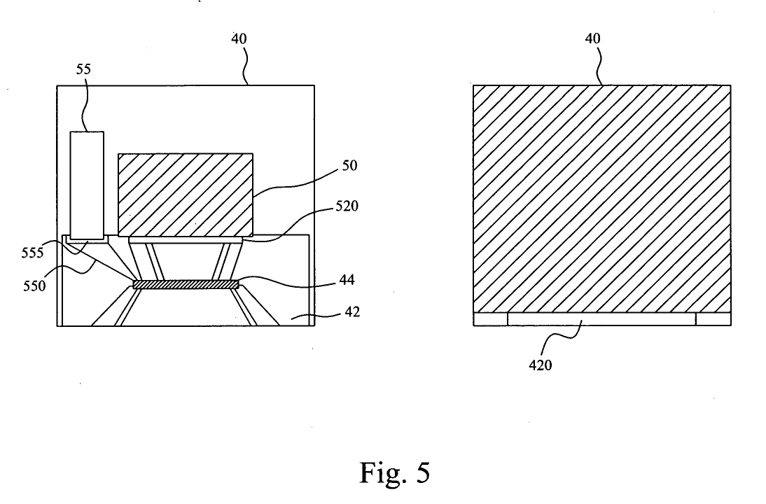

FIG. 4 shows a side view of the dual OLED panel module of FIG. 3 after the common package 42 is folded, and the sub-panel 50 and the common package 42 are attached to the backside of the main panel 40. FIG. 5 shows the front side and back side of the packaged module of FIG. 4. In this embodiment, the thickness of the dual OLED panel module is the sum of the main panel 40 and the sub-panel 50, and its height is almost equal to that of the main panel 40. Compared with the conventional dual OLED panel module shown in FIGS. 1 and 2, this embodiment does not use a PCB, but attaches the two panels 40 and 50 back to back directly, and furthermore, uses only one package 42 and only controller chip 44. Therefore, it needs lower cost, is thinner, and has smaller size.

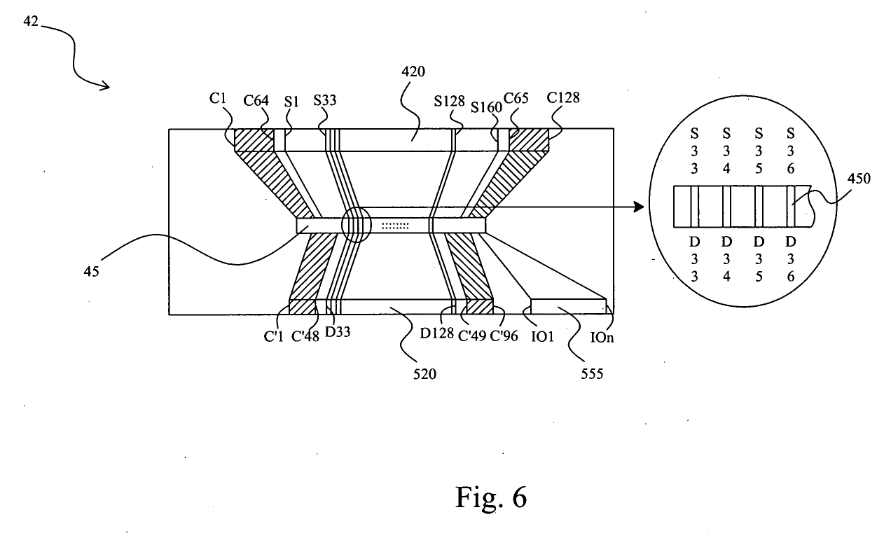

FIG. 6 shows an embodiment for the common package 42 of FIG. 3, which comprises a polymer tape with metal wires thereon, and usually the polymer tape is made of polyimide (PI). In this embodiment, the main panel 40 to be packaged has a hardware resolution of 160×128 (160 segment lines by 128 common lines), the sub-panel 50 to be packaged has a hardware resolution of 96×96 (96 segment lines by 96 common lines), the wires on the common package 42 are grouped into the main panel segment wires S1-S160, the main panel common wires C1-C128, the sub-panel segment wires D33-D128, the sub-panel common wires C′1-C′96, and the connector wires IO1-IOn. All the wires have their one terminal connected to the controller chip package area 45, and the other terminal connected to one of the bonding areas 420, 520, and 555. For uniform display, the main panel common wires C1-C128 are separated into two groups of C1-C64 and C65-C128, and disposed out of two sides of the main panel segment wires S1-S160, and the sub-panel common wires C′1-C′96 are also separated into two groups of C′1-C′48 and C′49-C′96, and disposed out of two sides of the sub-panel segment wires D33-D128. In this embodiment, as shown in the enlarged diagram on the right side of FIG. 6, there are some metal links 450 across the controller chip package area 45 to connect the main panel segment wires S33-S128 to the sub-panel segment wires D33-D128, and therefore the segment signals S33-S128 for the main panel 40 are also used by the sub-panel 50. Since the sub-panel segment wires D33-D128 for the sub-panel 50 receive the common segment signals from the main panel segment wires S33-S128 for the main panel 40, the sub-panel segment wires D33-D128 may not be bonded to the controller chip 44.

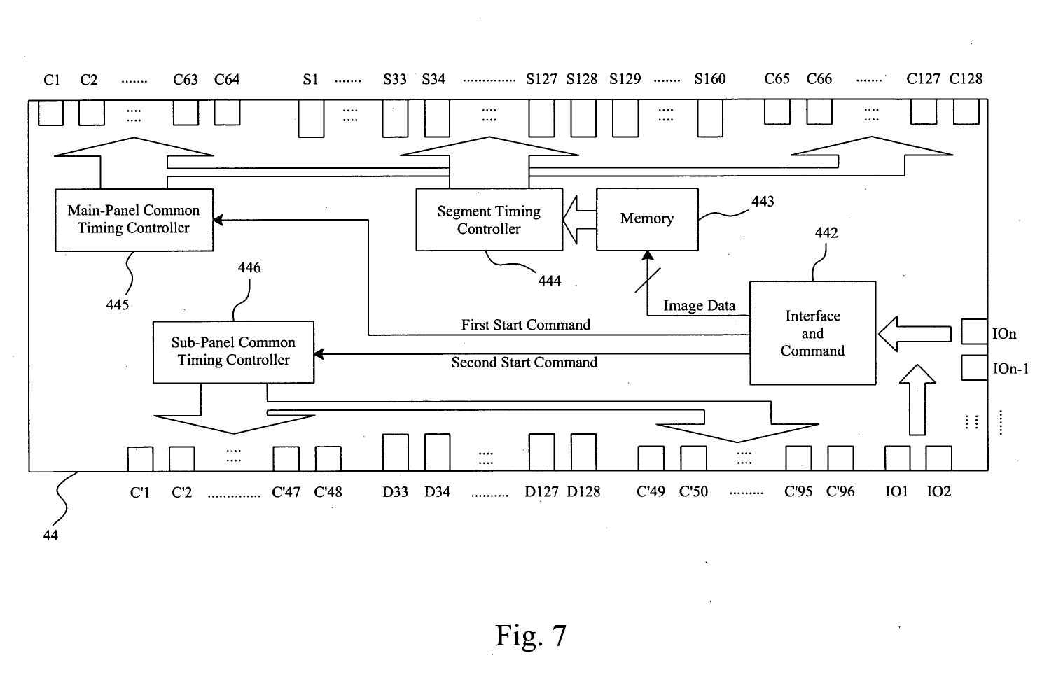

FIG. 7 shows an embodiment for the controller chip 44 of FIG. 3, which has a plurality of bonding pads, named as the wires to be bonded thereon for easier illustration. The external control signals are inputted to the controller chip 44 through the bonding pads IO1-IOn, and an interface and command unit 442 receives the external control signals. The external control signals may fill the image data to a memory 443, or set commands to a main panel common timing controller 445 and a sub-panel common timing controller 446 to let them generate the control signals of segment and common to drive the main panel 40 and the sub-panel 50. In further detail, the interface and command unit 442 may push the image data to the buffer memory 443, and send a first start command to the main panel common timing controller 445 and a second start command to the sub-panel common timing controller 446, in order to drive the main panel 40 and the sub-panel 50 simultaneously or either one. Upon the first and second start commands respectively, the main panel common timing controller 445 and the sub-panel common timing controller 446 produce a plurality of first and second common signals C1-C128 and C′1-C′96 for the main panel 40 and the sub-panel 50 to the respective bonding pads. Typically, the memory 443 is a random-access memory (RAM) for buffering the image data for the main panel 40, and shared by the sub-panel 50. The segment timing controller 444 may produce the segment signals S1-S160 according to the image data to transmit to the main panel 40 through the bonding pads S1-S160. Although the common segment signals in this embodiment are delivered from the main panel segment wires S33-S128 to the sub-panel segment wires D33-D128 through the metal links 450 of the common package 42, which has been illustrated in FIG. 6, the controller chip 44 still has bonding pads D33-D128 for bonding to the sub-panel segment wires D33-D128, in order for higher package yield and better package flatness. However, these bonding pads D33-D128 are dummy pads, without electrical connections to any functional circuit inside the controller chip 44.

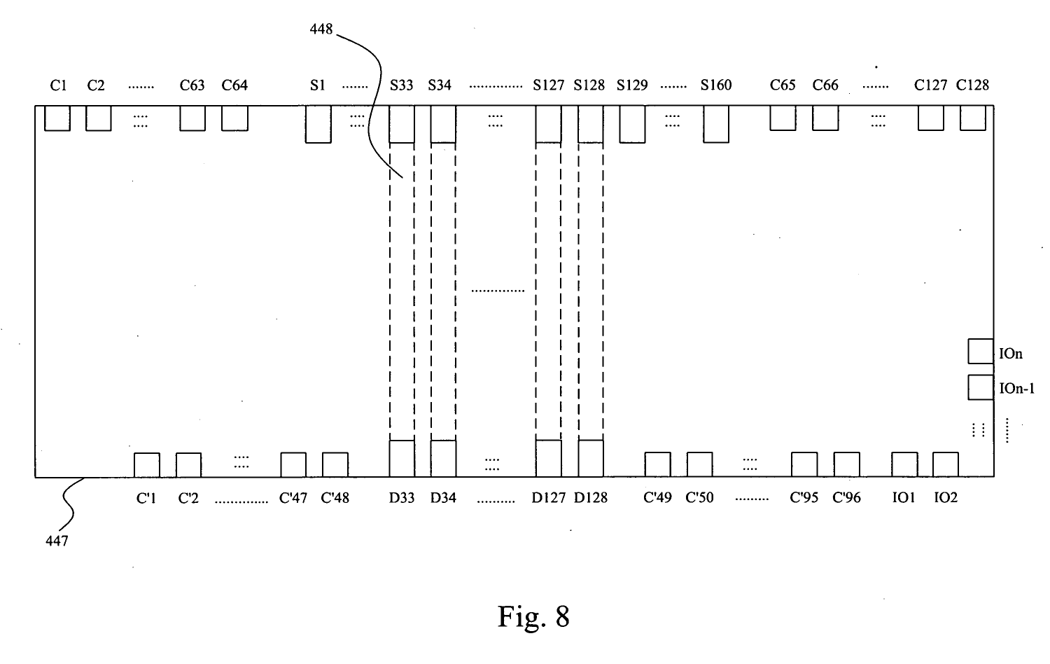

FIG. 8 shows another embodiment for the control circuit according to the present invention. The controller chip 447 has the same functional circuit as those blocks shown in FIG. 7, which are not shown hereof again. In the controller chip 447, a plurality of interconnections 448 are provided between the bonding pads S33-S128 and the bonding pads D33-D128, such that the segment signals S33-S128 for the main panel 40 are delivered to the sub-panel 50. In this embodiment, since the common segment signals S33-S128 are passed through the interconnections 448 within the controller chip 447, the common package 42 does not need the metal links 450 to connect the main panel segment wires S33-S128 to the sub-panel segment wires D33-D128, and the bonding pads D33-D128 of the controller chip 447 have to be bonded to the sub-panel segment wires D33-D128. Therefore, the common segment signals S33-S128 will be delivered to the sub-panel 50 from the bonding pads S33-S128 through the interconnections 448, the bonding pads D33-D128, and the sub-panel segment wires D33-D128 on the common package 42.

Although the embodiments shown in FIGS. 7 and 8 are so designed that all the controller circuit is provided by only one controller chip, they may be provided by two or more chips in other embodiments.

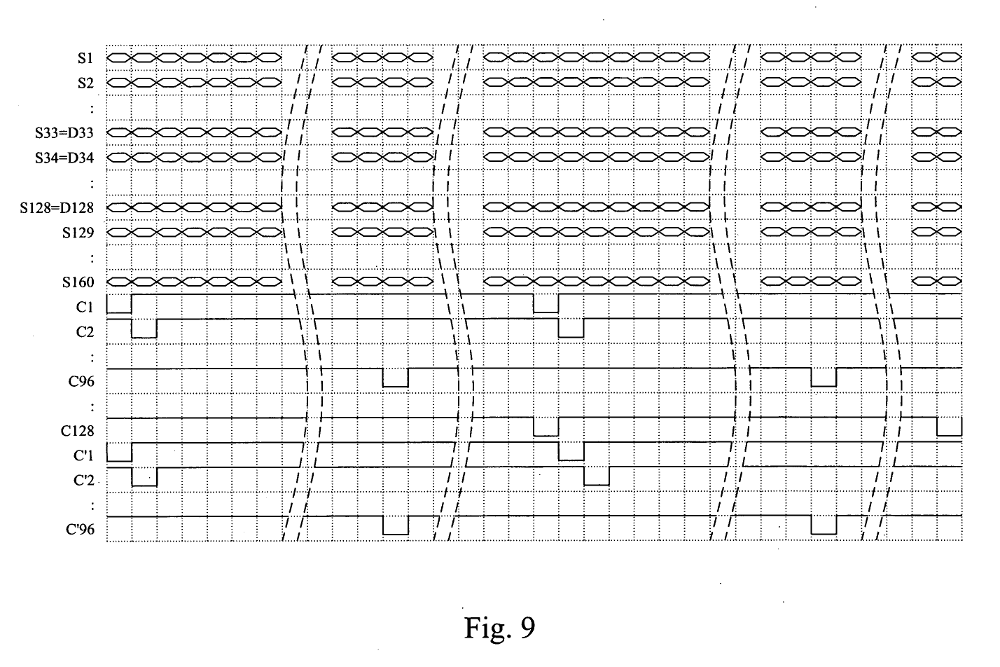

FIG. 9 shows the signals of the controller chip 44 of FIG. 7 when the main panel 40 and the sub-panel 50 both are active. In this case, the main panel segment signals S1-S160 produced by the controller chip 44 are the control signals for displaying the image, the sub-panel segment signals D33-D128 are the same as the main panel segment signals S33-S128 since the former are derived from the latter, and the main panel common signals C1-C128 and the sub-panel common signals C′1-C′96 are the scanning signals for continuously and sequentially scanning the main panel 40 and the sub-panel 50 respectively, such that the main panel 40 and the sub-panel 50 display a same image at the same time.

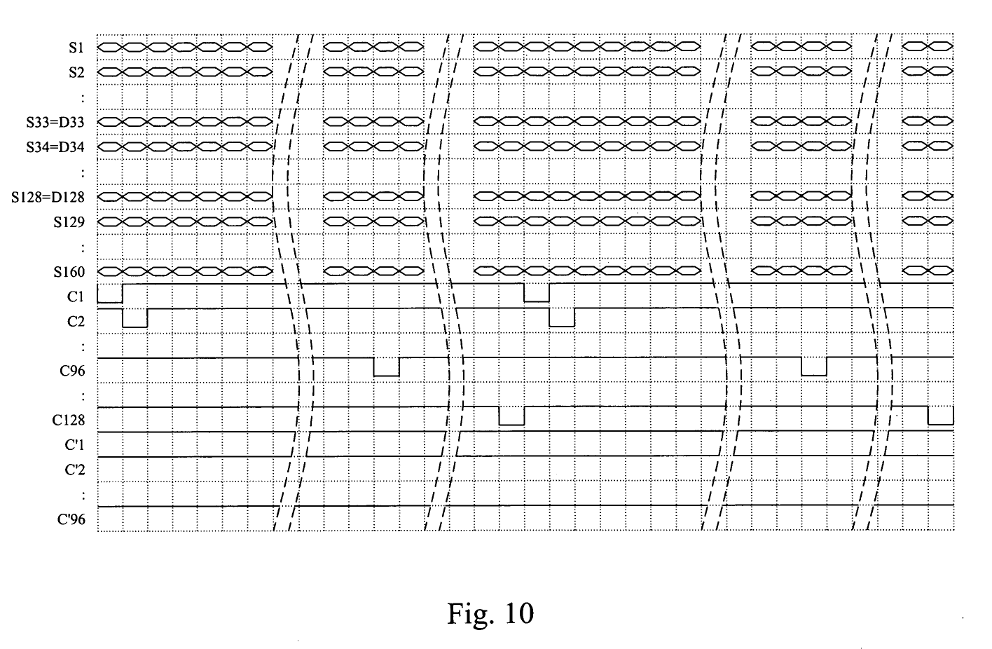

FIG. 10 shows the signals produced by the controller chip 44 of FIG. 7 when the main panel 40 is active and the sub-panel 50 is turned off. The main panel segment signals S1-S160 are the control signals for displaying the image, and the sub-panel segment signals D33-D128 are the same as the main panel segment signals S33-S128. In this case, however, the main panel common signals Cl-C128 are used so as to continuously and sequentially scan the main panel 40, while the sub-panel common signals C′1-C′96 are kept at high level to turn off the sub-panel 50. Therefore, only the main panel 40 displays the image.

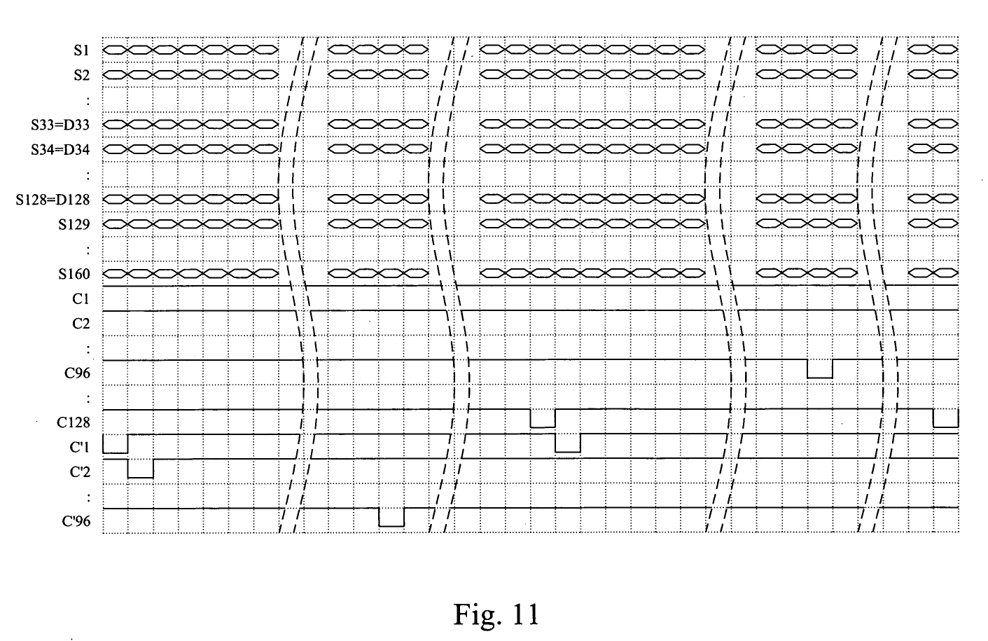

FIG. 11 shows the signals produced by the controller chip 44 of FIG. 7 when the main panel 40 is turned off and the sub-panel 50 is active. Likewise, the main panel segment signals S1-S160 are the control signals for displaying the image, and the sub-panel segment signals D33-D128 are the same as the main panel segment signals S33-S128. However in this case, the main panel common signals C1-C128 are kept at high level to turn off the main panel 40, while the sub-panel common signals C′1-C′96 are used so as to continuously and sequentially scan the sub-panel 50. Therefore, only the sub-panel 50 displays the image.

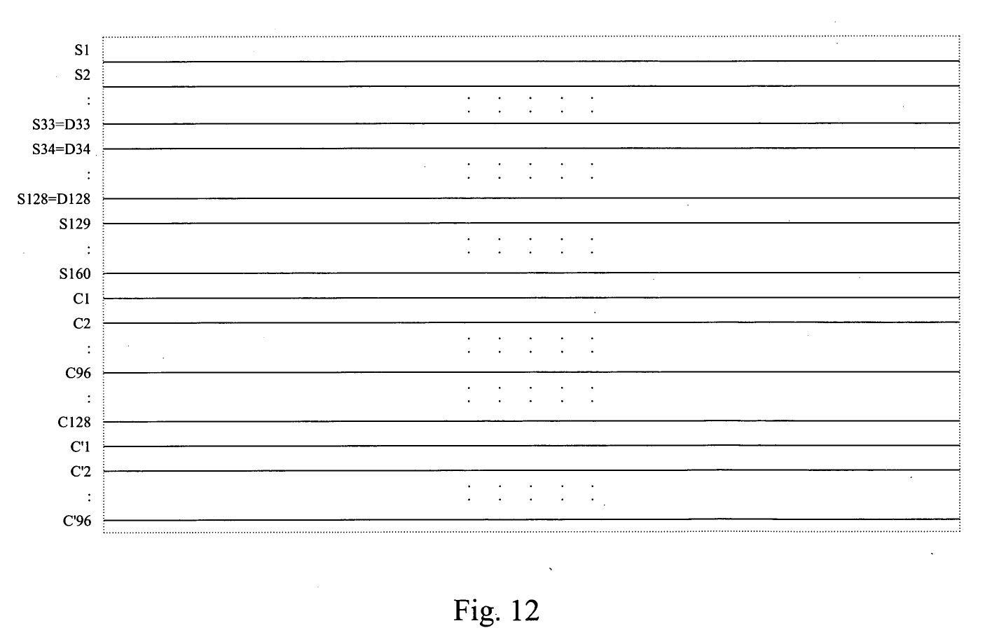

FIG. 12 shows the signals produced by the controller chip 44 when the main panel 40 and the sub-panel 50 both are turned off. The segment signals S1-S160 and D33-D128 all are keep at low level (e.g. zero voltage), and the common signals C1-C128 and C′1-C′96 all are kept at high level.

As shown in the above embodiments, in one dual OLED panel module according to the present invention, only one package is needed to link the driving signals for twp panels and the external control signals, one controller chip can drive the two panels, the controller chip provides different common signals and same segment signals for the two panels, the two panels share one buffer memory, only one segment timing controller is needed for the two panels, and no PCB is required to combine the two panels together.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A dual OLED panel module, comprising:
a first OLED panel;
a second OLED panel;
a common package having a first bonding area and a second bonding area for bonding to the first and second OLED panels respectively; and
a control circuit for providing a plurality of driving signals from a plurality of external control signals to drive the first and second OLED panels simultaneously or either one through the common package.

2. The dual OLED panel module of claim 1, wherein the common package is bonded to the first and second OLED panels by a tape automated bonding.

3. The dual OLED panel module of claim 1, wherein the common package and the second OLED panel are attached to a backside of the first OLED panel.

4. The dual OLED panel module of claim 1, further comprising a connector bonded to the common package for receiving the external control signals to forward to the control circuit.

5. The dual OLED panel module of claim 4, wherein the connector comprises a flexible PCB, a hot bar, or a PCB substrate.

6. The dual OLED panel module of claim 1, wherein the driving signals comprises a plurality of common signals for the first and second OLED panels.

7. The dual OLED panel module of claim 6, wherein the common package comprises:
a plurality of first wires connected between the control circuit and the first OLED panel for transmitting a plurality of first signals among the driving signals;
a plurality of second wires connected between the control circuit and the second OLED panel for transmitting a plurality of second signals among the driving signals;
a plurality of third wires connected to the second OLED panel; and
a plurality of conductive links, each for linking one of the third wires to one of the first wires, so as to transmit at least a portion of the common signals to the third wires.

8. The dual OLED panel module of claim 7, wherein the control circuit comprises:
a memory;
an interface and command unit for providing a first start command and a second start command and buffering an image data to the memory upon the external control signals;
a segment timing controller for providing a plurality of segment signals according to the image data, wherein the first signals include the segment signals, and the segment signals include the common signals;
a first common timing controller for providing a plurality of first common signals upon the first start command, wherein the first signals include the first common signals; and
a second common timing controller for providing a plurality of second common signals upon the second start command, wherein the second signals include the second common signals.

9. The dual OLED panel module of claim 8, wherein the segment signals further include a plurality of signals which are not commonly used by the first and second OLED panels.

10. The dual OLED panel module of claim 6, wherein the common package comprises:
a plurality of first wires connected between the control circuit and the first OLED panel for transmitting a plurality of first signals among the driving signals; and
a plurality of second wires connected between the control circuit and the second OLED panel for transmitting a plurality of second signals among the driving signals;
wherein the first and second signals respectively include the common signals.

11. The dual OLED panel module of claim 10, wherein the control circuit comprises:
a memory;
an interface and command unit for providing a first start command and a second start command and buffering an image data to the memory upon the external control signals;
a segment timing controller for providing a plurality of segment signals according to the image data, wherein the first signals include the segment signals, and the segment signals include the common signals;
a first common timing controller for providing a plurality of first common signals upon the first start command, wherein the first signals include the first common signals;
a second common timing controller for providing a plurality of second common signals upon the second start command, wherein the second signals include the second common signals;
a plurality of first bonding pads for bonding the first wires;
a plurality of second bonding pads for bonding the second wires; and
a plurality of interconnections, each for electrically connecting one of the second bonding pads to one of the second first bonding pads, so as to transmit at least a portion of the common signals to the second bonding pads.

12. The dual OLED panel module of claim 1, wherein the segment signals further include a plurality of signals which are not commonly used by the first and second OLED panels.
